(19) United States
(12) Patent Application Publication
(10) Pub. No.: US 2017/0083831 A1
(43) Pub. Date: Mar. 23, 2017

(54) REAL-TIME WAIT ESTIMATION AND PREDICTION VIA DYNAMIC INDIVIDUAL AND GROUP SERVICE EXPERIENCE ANALYSIS

(71) Applicant: INTERNATIONAL BUSINESS MACHINES CORPORATION, ARMONK, NY (US)

(72) Inventors: RAHUL GHOSH, MORRISVILLE, NC (US); WILLIAM R. LARICCIA, DURHAM, NC (US); RAVI K. MUTHUKRISHNAN, BANGALORE (IN); AARON J. QUIRK, DURHAM, NC (US); XIAN JUN ZHU, SHANGHAI (CN)

(21) Appl. No.: 14/862,253

(22) Filed: Sep. 23, 2015

(51) Int. Cl. G06Q 10/02

(52) U.S. Cl. CPC G06Q 10/02

(57) ABSTRACT

An individual average service experience by each of one or more customers at a service area provided by a service provider is computing based on a current service experience and at least one previous individual service experience of each of the one or more customers. A group average service experience for a group of customers at the service area is computed based on the individual average service experience by each of the one or more customers in the group of customers and at least one previous group service experience by the group of customers. One or more wait times until the group completes use of the particular service area are dynamically estimated, based on the group average service experience.

### BACKGROUND

1. Technical Field

The embodiment of the invention relates generally to sensors and particularly to real-time wait estimation and prediction via dynamic individual and group service experience analysis.

2. Description of the Related Art

There are many service providers that require potential customers to wait for service until current customers have completed use of a service area.

### BRIEF SUMMARY

Therefore, in view of the foregoing, there is a need for a method, system, and computer program product for real-time wait time estimation and prediction to provide customers with accurate information about expected service.

In one embodiment, a method is directed to a computer system dynamically computing, for each of one or more customers at a particular service area from among multiple service areas provided by a service provider over a period of time, an individual average service experience by each of the one or more customers from the service provider based on a current service experience and at least one previous individual service experience of each of the one or more customers. The method is directed to the computer system dynamically computing, for a group of customers using the particular service area from among the one or more customers over the period of time, a group average service experience for the group of customers based on the individual average service experience by each of the one or more customers in the group of customers and at least one previous group service experience by the group of customers. The method is directed to the computer system dynamically estimating, based on the group average service experience, one or more wait times until the group completes use of the particular service area.

In another embodiment, a system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprising program instructions to dynamically compute, for each of one or more customers at a particular service area from among multiple service areas of a service provider over a period of time, an individual average service experience by each of the one or more customers from the service provider based on a current service experience and at least one previous individual service experience of each of the one or more customers. The stored program instructions comprising program instructions to dynamically compute, for a group of customers using the particular service area from among the one or more customers over the period of time, a group average service experience for the group of customers based on the individual average service experience by each of the one or more customers in the group of customers and at least one previous group service experience by the group of customers. The stored program instructions comprising program instructions to dynamically estimate, based on the group average service experience, one or more wait times until the group completes use of the particular service area.

In another embodiment, a computer program product comprises one or more computer-readable storage devices and program instructions, stored on at least one of the one or more storage devices. The stored program instructions comprising program instructions to dynamically compute, for each of one or more customers at a particular service area from among multiple service areas of a service provider over a period of time, an individual average service experience by each of the one or more customers from the service provider based on a current service experience and at least one previous individual service experience of each of the one or more customers. The stored program instructions comprising program instructions to dynamically compute, for a group of customers using the particular service area from among the one or more customers over the period of time, a group average service experience for the group of customers based on the individual average service experience by each of the one or more customers in the group of customers and at least one previous group service experience by the group of customers. The stored program instructions comprising program instructions to dynamically estimate, based on the group average service experience, one or more wait times until the group completes use of the particular service area.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates one example of block diagram of a system for real-time wait time estimation and prediction via dynamic individual and group organization service experience analysis;

FIG. 2 illustrates one example of a block diagram of a system for real-time wait time estimation and prediction based on individual and group service experience pattern analysis;

FIG. 3 illustrates one example of a block diagram of entries in a user database and entries in a group database;

FIG. 4 illustrates one example of a block diagram of a wait time management controller for aggregating real-time wait time estimates based on service area size requirements for a particular user;

FIG. 5 illustrates one example of a block diagram of an output interface for a GPS organization service specifying real-time wait time estimates for organizations within a particular proximity of a location selected by a user;

FIG. 6 illustrates one example of a block diagram of a computer system in which one embodiment of the invention may be implemented;

FIG. 7 illustrates a high level logic flowchart of a process and computer program for managing individual customer detection and profile management for a organization;

FIG. 8 illustrates a high level logic flowchart of a process and computer program for managing group customer detection and profile management for a service provider;

FIG. 9 illustrates a high level logic flowchart of a process and computer program for estimating a wait time for a service area;

FIG. 10 illustrates a high level logic flowchart of a process and computer program for determining a wait time estimate by service area size; and

FIG. 11 illustrates a high level logic flowchart of a process and computer program for managing output of accumulated wait times by party size through a location based service.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

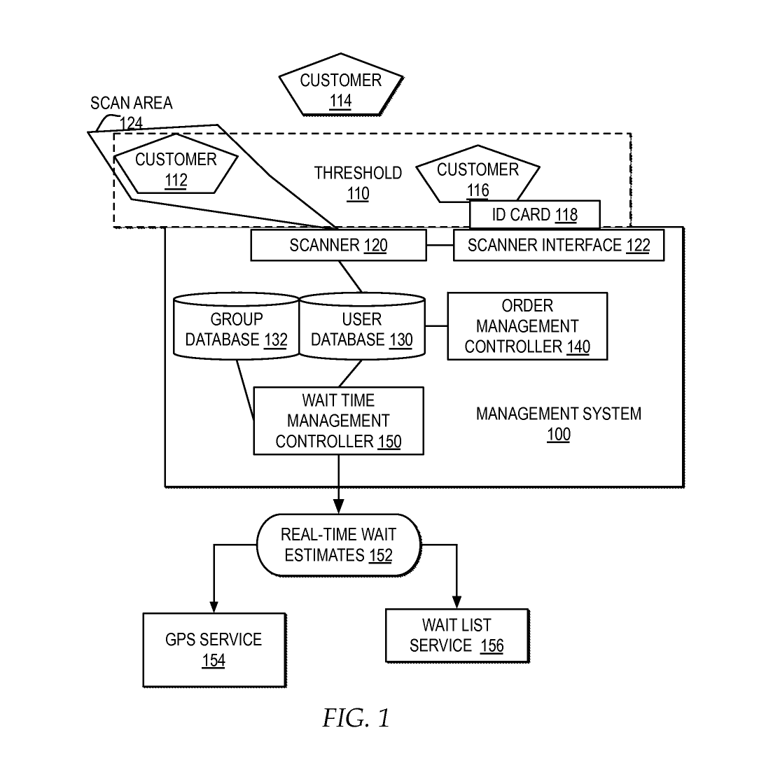

FIG. 1 illustrates a block diagram of one example of a system for real-time wait time estimation and prediction via dynamic individual and group service experience analysis.

In one example, one or more types of service providers may implement a management system 100 for managing real-time wait time estimation and prediction of service area available for service areas provided by the service provider. For example, a wait time management controller 150 of management system 100 may perform real-time wait time estimation and prediction of service area availability for one or more service areas provided by a service provider. In one example, as described herein, management system 100 and wait time management controller 150 may be implemented for a service provider providing a restaurant, with service areas representing tables, bar areas, or other areas with a capacity, and with services including one or more meals. In another examples, one or more of management system 100 and wait time management controller 150 may be implemented by service providers other than a restaurant where there is a wait time for customers to access resources or services provided by the service providers. For example, one or more of management system 100 and wait time management controller 150 may be implemented by a service provider managing event ticketing and entry, with service areas representing capacity controlled areas within the event. For example, management system 100 and wait time management controller 150 may be implemented by a service provider providing a call center, with service areas representing conference calls or help desk calls.

In addition, one or more service provider management functions may be integrated within or accessible to management system 100. For example, management system 100 may also manage an order management controller 140 that manages one or more of the functions for one or more interfaces through which orders are placed by service area, including, but not limited to, outputting order information to a meal preparation area, tracking an amount of time required to prepare an item from when an order is placed, tracking when items for an order are ready, tracking when items for an order are picked up for delivery to a service area, and managing billing for each order. In one example, order management controller 140 may include an integrated billing management system or may access a billing management system.

In one example, to perform real-time wait time estimation and prediction of service area availability, management system 100 may implement one or more scanners, such as a scanner 120, for scanning for one or more types of identifying information about customers entering or exiting one or more threshold areas provided by the service provider, such as a threshold 110. In one example, management system 100 may include additional scanners distributed throughout for scanning within threshold 110. In one example, management system 100 may include additional thresholds, with additional scanners distributed throughout the additional thresholds. In another example, management system 100 may include one or more scanners specified for detecting customers arriving at a threshold and one or more scanners specified for detecting customers depart from a threshold. In one example, threshold 110 may represent a location through which all customers enter or exit a location provided by a service provider. In another example, threshold 110 may represent an area surrounding a particular service area, where each service area includes a separate scanner 120 for scanning one or more types of identifying information about the customers sitting down at each particular service area. In another example, threshold 110 may represent one or more types of thresholds that are not physical, such as an electronic threshold, a network threshold, and a telephonic threshold.

In one example, scanner 120 may include one or more scanning devices enabled to capture a digital or video image of a face of a customer within a scan area 124 of threshold 110 and to uniquely identify a customer by analyzing the image and performing facial recognition. In one example, scanner 120 may access a user database 130 including previously scanned images or previously analyzed facial features of customers, to compare a current scanned image with the previously scanned or analyzed image to match the current customer to a profile from a previous visit. In another example, if scanner 120 does not detect a previously scanned image matching a currently scanned image, scanner 120 may store the currently scanned image in user database 130 with a unique user identifier (ID) selected by scanner 120, to add a unique identifier for a new customer to user database 130. In additional or alternate examples, scanner 120 may include a scanner enabled to detect and analyze biometric information of a customer, such as a fingerprint scanner or eye iris recognition scanner, to uniquely identify the customer.

In another example, scanner 120 may include a scanner interface 122 that may passively or actively read or receive signals of other forms of identification from a customer to enable scanner 120 to uniquely identify the customer. In one example, scanner interface 122 may implement a reader for reading a smartcard with an embedded microchip with a unique identifier, reading a card including a quick response (QR) code or other barcode that is scannable to detect a unique identifier, reading a card including an radio frequency identifier (RFID) chip with a unique identifier, or reading one or more other unique identification devices, which when read by scanner 120, enables scanner 120 to uniquely identify the customer. A service provider may issue a unique identification device or scanner 120 may scan unique identification devices issued to customers for multiple purposes. For example, a customer may carry a smartcard that functions as a credit card, and when read by scanner 120, uniquely identifies the customer for the service provider. Scanner interface 122 may include one or more of a wireless scanning interface and a touch scanning interface.

In another example, scanner interface 122 may include a wireless receiver that passively or actively receives local broadcasts, such as a Bluetooth enabled broadcast, from a unique identification device that broadcasts a unique identification in a local area, such as a portable electronic device or battery enabled RFID chip that broadcasts a unique identifier using a Bluetooth or near field communication (NFC) network. In one example, a portable electronic device may also include an application that detects scanner interface 122, determines whether scanner interface 122 is authenticates as authorized to receive the user identification, and if scanner interface 122 authenticates as authorized to receive the user identification, transmits the unique identification to scanner interface 122.

In one example, as each customer is detected entering threshold 110, the customer is either identified as a returning visitor, and the customer's profile of previous service experience is retrieved from user database 130, or the customer is identified as a new visitor, and a customer profile is created for the customer in user database 130. In one example, as an incentive for customers to provide identifying information upon reaching threshold 110, management system 100 may include an incentive controller that generates and gives returning customers coupons, discounts, or other types of incentives for use during a current meal or a subsequent meal. In one example, management system 100 may add incentives to a user profile in user database 130, for redemption through order management controller 140. In one example, if a service provider is able to identify that a group includes customers, but not able to uniquely identify the customer in some way, management system 100 may assign a generic profile to the customer, such as a generic “visitor” profile that includes averaged information.

In one example, wait time management controller 150 identifies, based on the unique user identification determined by scanner 120, the one or more customers in a group of customers seated at a particular service area. In one example, wait time management controller 150 may detect a grouping of customers from a group of one or more customers identified together by scanner 120 within threshold 110, may detect a grouping of customers from user identifiers identified in association with an order in order management controller 140, or may detect a grouping of customers from other entries by customers detected by management system 100. In one example, wait time management controller 150 may maintain a group database 132 that includes a separate group profile for each group of one or more customers identified together. In one example, wait time management controller 150 may scan group database 132 with the one or more user IDs identified for a particular group from user database 130 to determine whether there is a previously visiting group profile with the same selection of one or more user IDs. If wait time management controller 150 identifies a previous visiting group profile with the same selection of the one or more user IDs in a current grouping of customers, then wait time management controller 150 accesses the group profile from group database 132 and updates the group profile with current group service experience data. In one example, if wait time management controller 150 does not identify a previous visiting group profile with the same selection of the one or more user IDs in a current grouping of customers, then wait time management controller 150 may create a new group profile in group database 132 and add the user IDs in a current grouping of customers.

In one example, wait time management controller 150 may track, within individual user profiles for each customer in user database 130, and collectively for the group, in a group profile in group database 132, one or more aspects of the individual and group service experience provided by a service provider, where wait time management controller 150 may determine, based on the individual and group service experience, a progress of the use of a service area and estimate a wait time for the service area in real-time. Based on the individual and group service experience, wait time management controller 150 may identify patterns of eating habits and eating times for individuals and by group. In one example, patterns in an individual's eating habits and eating times may be vary depending on the group of customers the individual is eating with, such that monitoring and detecting patterns by both individual and by group allows wait time management controller 150 to estimate even more accurate meal times than if only individual patterns were monitored.

In one example, wait time management controller 150 may track, for each individual customer in user database 130, one or more of a time the customer checked in and a time the customer checked out, to determine a total time that the customer used a service area. In one example, wait time management controller 150 may detect check in and check out times from one or more inputs including, but not limited to scanner 120 detecting a customer entering or departing threshold 110, scanner interface 122 detecting a customer's portable electronic device present within threshold 110 or no longer present within threshold 110, order management controller 140 detecting a customer scheduled to be seated at a service area, order management controller 140 detecting a customer order placement, order management controller 140 detecting a customer pay a bill, and other customer entry and exit indicators detected by or received by management system 100.

In one example, wait time management controller 150 may detect one or more consumable items that are ordered or delivered, by individual or by group. In one example, wait time management controller 150 may detect the one or more consumable items ordered by one or more individuals or by a group from order management controller 140 through one or more interfaces of order management controller 140. In one example, order management controller 140 may provide an interface at each service area through which individual customers place an order. In another example, a waiter may individually identify guests at a service area when entering an order for the service area into an interface of order management controller 140. In another example, one or more customers may be assisted in placing individual orders through order management controller 140, which are assigned to one or more order numbers, which are assigned to a particular group or service area. In one example, wait time management controller 150 may also detect one or more consumable items ordered by one or more individuals or by a group from sensing identifiers from one or more identification chips, such as RFID chips, positioned on the containers for individual consumable items, where the one or more identification chips are passively or actively detected to read the identification of the consumable item container. In additional or alternate examples, management system 100 may include additional or alternate interfaces through which the specific items ordered, by individual or by group, may be identified and provided to wait time management controller 150.

In one example, wait time management controller 150 may dynamically analyze the service experience for each individual customer identified in a group based on one or more of the types of experience data tracked and if the customer is a returning customer, based on the customer's previous experience as monitored in a user profile. In one example, wait time management controller 150 may determine a type of meal that each customer in a group is most likely consuming, based on a time of day or other factor. In one example, wait time management controller 150 may then filter or assign a higher ranking to previous experience data tracked for the individual customer, in the customer's profile, for same type of meal. In one example, wait time management controller 150 may calculate an average preparation and consumption time for each consumable item, by individual, based on a general average preparation and consumption time for each consumable item, and adjusted for the previous experience data tracked for the individual customer, in the customer's profile, for the same or similar type of consumable item, if the customer is a returning customer. In one example, wait time management controller 150 may calculate an average time of stay for each individual customer based on general average time of stay for customers during the current meal type, adjusted based on the previous time of stay data tracked for the individual customer, in the customer's profile, if the customer is a returning customer. In one example, wait time management controller 150 may calculate an average number of guests who typically accompany the individual customer, based on group size tracking for the individual customer, in the customer's profile, if the customer is a returning customer.

In addition, wait time management controller 150 may dynamically analyze the service experience for each group of customers based on the analyzed service experience for each of the individual customers within the group, based on one or more types of experience data tracked for the group overall, and if the group is a returning group, based on the group's previous experience as monitored in a group profile. In one example, if a group is a new group, even though some of the customer's service experience patterns may be available from returning customer profiles, there may be new customers or a new combination of customers with unknown service experience patterns. In one example, if a group is a new group, wait time management controller 150 may apply a worst case estimation or predict averages and wait time based on the slowest customer in the group. In another example, if a group is not a new group, wait time management controller 150 may apply median case estimates, based on the group's previous service experience data tracked in the group profile. In one example, wait time management controller 150 may also filter or assign a higher ranking to previous experience data tracked for the group, in the group's profile, for the same type of meal. In one example, wait time management controller 150 may calculate an average preparation and consumption time for the consumable items ordered by a group, based on the average preparation time for each consumable item calculated for each individual in the group, and adjusted for the average preparation and consumption time for each of the consumable items for the group, in the group's profile, if the group is a returning group or adjusted for the worst-case estimate if the group is not a returning group. In one example, wait time management controller 150 may calculate an average time of stay for the group, based on the average time of stay calculated for each individual in the group, and adjusted for the average time of stay for the group, in the group's profile, if the group is a returning group, or adjusted for the worst case estimate if the group is not a returning group. In one example, the service experience of individual customers may vary based on the type and size of group the customer is eating with, along with the time of day. In one example, by predicting average preparation and consumption times of consumable items for a particular group based on the individual and group history of service experience with the consumable items for the particular group, the predicted times are more accurate than the worst case times or slowest guest times per consumable item. In addition, by predicting time of stay for a particular group based on the individual and group history of service experience, the predicted times are more accurate than the worst case group times per stay.

In one example, wait time management controller 150 may dynamically calculate, based on analysis of the individual and group service experience for a service area, one or more real-time wait estimates 152, by service area. Real-time wait estimates 152, based on individual and group service experience analysis, along with order and billing time estimates provided by order management controller 140, may provide a fair, real-time approximation of the time remaining before a service provider may use a service area for a next customer. Real-time wait estimates 152 may specify a predicted completion time for a meal and a time at which a service area will be vacated based on the individual and group service experience of a total meal time for a current type of meal.

In addition, wait time management controller 150 may monitor, and dynamically adjust real-time wait estimates 152, based on a number of users already on a wait list for a service provider, where wait time management controller 150 may provide an interface through which a user, or hostess on a behalf of a user, may place users on a wait list for the service provider. In addition, wait time management controller 150 may monitor, and adjust real-time wait estimates 152 based on the service area sizes requested by users already on a wait list for a service provider, where each service area managed by management system 100 may also include a maximum seating capacity. In one example, providing customers with accurate, real-time wait list estimates is important for customer retention because if an estimated wait time is too short, customers may become frustrated with longer than expected waits, and decide not to return to receive service from the service provider. In addition, in one example, providing customers with accurate, real-time wait list estimates is important when a service provider has service areas available immediately, to keep service areas filled and increase the productivity of the service provider.

Wait time management controller 150 may output the real-time wait estimates, by service area, as real-time wait time estimates 152. In one example, real-time wait time estimates 152 may be output to one or more systems for output to potential customers. In one example, real-time wait time estimates 152 may be broadcast, where devices enabled to receive broadcasts of real-time wait time estimates 152 may detect and publish the data. In another example, real-time wait time estimates 152 may be output to one or more specific hardware devices. In one example, real-time wait time estimates 152 may be output to one or more databases or services, for access by one or more applications or services.

In one example, real-time wait time estimates 152 may be output to a global positioning system (GPS) service 154 that integrates wait time estimates from one or more service providers into a service that provides real-time wait estimates of one or more service providers detected within a particular proximity of a particular user's specified location. In one example, a user's specified location may include a current location, as detected by a GPS component for GSP service 154. In another example, a user's specified location may include a future location, as specified by a user. In one example, GPS service 154 may represent an application specified for running on a mobile computing device enabled with a GPS sensor.

In one example, by wait time management controller 150 calculating and outputting real-time wait time estimates 152 to GPS service 154, a service provider may optimize service area management to potentially increase profitability. In one example, by providing customers with real-time wait estimates 152 through GPS service 154, a customer may receive real-time wait estimates, by service provider, for a particular party size, without needing to call or walk in to a location provided by the service provider, which provides the customer with greater predictability for a wait time at the service provider and provides the service provider with the opportunity to optimize service area management through publishing real-time wait time estimates.

In another example, real-time wait time estimates 152 may be output to a wait list service 156 that monitors, once a user has selected to enter a wait list, the user's position on the wait list. In one example, wait list service 156 may update each user's wait list entry with an estimated wait time for the user based on the user's position in the wait list and real-time wait time estimates 152.

In one example, existing wait list services, such as wait list service 156, may implement hardware devices, such as pagers or buzzers, that a customer is handed when the customer is placed on a wait list, and that automatically buzz or provide another notification when a service area is available for the customer, however, generally pagers or buzzers do not provide customers with real-time wait estimates. In one example, wait list service 156 may be updated to receive real-time wait time estimates 152 and to provide notifications to customers, through the pagers or buzzers, of the real-time wait estimates 152, through one or more output interfaces of the pager or buzzer, to provide customers with accurate information about the amount of time the customer will need to wait, through existing pagers or buzzers.

In addition, as wait time management controller 150 detects each consumable items as part of an order, wait time management controller 150 may access one or more nutrition aspects of each item, calculate a percentage of an item consumed based on the weight, calculate the nutritional value of the percentage of an item consumed based on the nutrition aspects, and output one or more of the nutrition aspects, percentage of item consumed, and calculated nutritional value of the percentage of an item consumed. In one example, management system 100 may locally broadcast the information, such that electronic devices accessible to customers at the service area may receive the broadcast information and output the information to the customers through one or more output interfaces of the electronic devices. For example, customers may carry electronic devices enabled to receive locally broadcast Bluetooth transmissions, such as portable phones or portable watches, and to output the broadcasted information to the customers.

In one example, while user database 130 and group database 132 are illustrated as single databases within management system 100, in additional or alternate embodiments, management system 100 may access one or more of user database 130 and group database 132 from a remote server system via a network. In addition, one or more of user database 130 and group database 132, or one or more parts of user database 130 and group database 132, may be shared between multiple management systems for a single service provider location or multiple service provider locations.

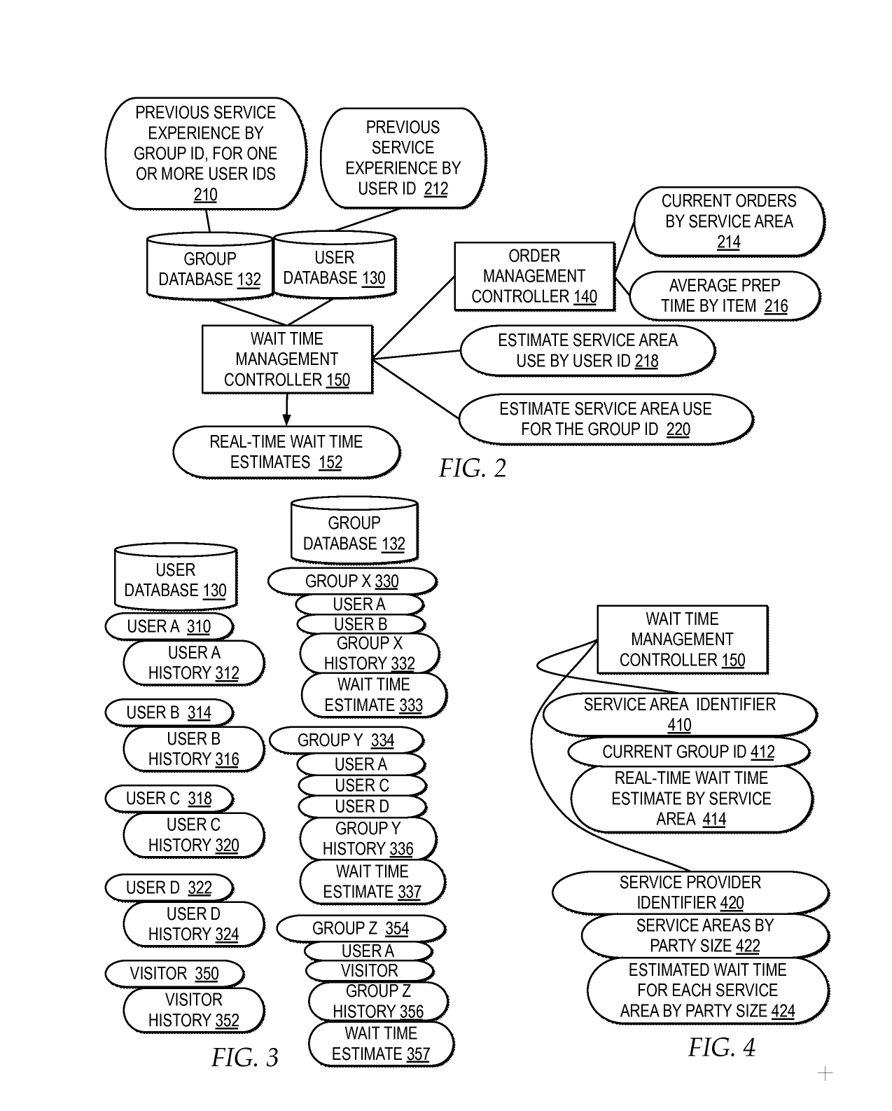

FIG. 2 illustrates a block diagram of one example of a system for real-time wait time estimation and prediction based on individual and group service experience pattern analysis.

In one example, wait time management controller 150 may receive one or more user IDs from scanner 120 and access, based on the user IDs one or more user profiles from user database 130, where each user profile may include previous service experiences organized by user ID, as illustrated at reference numeral 212. In addition, wait time management controller 150 may determine, by filtering entries in group database 132, whether there is a previously created group that includes the user IDs received for a group, where group database 132 includes previous service experience organized by group ID, for one or more user IDs, as illustrated at reference numeral 210.

In one example, order management controller 140 may monitor for one or more aspects of an order by a group. In one example, order management controller 140 may manage current orders by service area 214, where each current order may further specify particular consumable items and a particular user among a group that ordered each consumable item. In addition, order management controller 140 may manage average preparation and consumption times by item 216.

In one example, wait time management controller 150 may receive or request current orders by service area 214 and average preparation and consumption times by item 216. Wait time management controller 150 may analyze, for each of the individual customers in a group at a table, previous service experience by user ID 212 for each individual in a group, for each of the consumable items ordered under the user ID, as specified in current orders by service area 214, in view of average prep time by item 216. In one example, wait time management controller 150 may compute average preparation and consumption times for each user, for each ordered item. In addition, wait time management controller 150 may analyze, for the group of customers, the average service experience for each individual customer, in view of any previous service experience by group ID 210, for each of the consumable items ordered under each of the user IDs or a group ID, as specified in current orders by service area 214. In one example, wait time management controller 150 may compute average preparation and consumption times for each group, for the ordered items. In one example, if one or more of previous service experience by user ID 212 and previous service experience by group ID, for the one or more user IDs 210, does not include previous service experience by item for a particular user or a group that is currently at a service area, wait time management controller 150 may apply average prep time by item 216 and may also apply one or more rules, such as a worst-case scenario rule or slowest preparation and consumption time rule, when computing average preparation and consumption times per item.

In one example, wait time management controller 150 may also analyze, for each of the individual customers in a group at a service area, one or more entries from previous service experience by user ID 212, for each individual in the group, to compute an average stay time for each individual in the group. In addition, wait time management controller 150 may analyze, for each group at a service area, a group entry within previous service experience by group ID 210 and each the average stay time for each individual in the group, to compute an average stay time for the group. In one example, if one or more of previous service experience by user ID 212 and previous service experience by group ID, for the one or more user IDs 210, does not include previous service experience of one or more stay times for a particular user or a group that is currently at a service area, wait time management controller 150 may apply average stay time computed for a service area or group size and may also apply one or more rules, such as a worst-case scenario rule or slowest stay time rule, when computing average stay times.

In one example, wait time management controller 150 may also determine a time of arrival of each of the user IDs and the group ID and determine a type of meal associated with the time of arrival. Wait time management controller 150 may filter previous service experience by user ID 212 and previous service experience by group ID, for the one or more user IDs 210, for the time of arrival or type of meal. In one example, wait time management controller 150 may filter previous service experience by user ID 212 and previous service experience by group ID, for the one or more user IDs 210 prior to computing average preparation and consumption times for each individual and each group and prior to computing average stay times for each individual and for each group.

In one example, wait time management controller 150 computes, based on the individually combined average stay times for a group and the individually combined average preparation and consumption time per item for a group, specified for a type of meal, and additional real-time and average service information available within management system 100, real-time wait time estimates 152 providing a real-time, dynamic estimate of the amount of time until a particular service area used by a group will become available for a next group. In the example, wait time management controller 150 may fine tune the time in real-time wait time estimates 152 based on multiple real-time service experience factors, detected for individuals and aggregated for a group, that impact the total meal time for the group. In one example, order management controller 140 may provide additional real-time service experience information indicating when a group order is ready, the number of courses in the order, when a final bill for an order is tallied and printed, and when a final bill for an order is paid.

FIG. 3 illustrates a block diagram of one example of entries in a user database and entries in a group database.

In one example, user database 130 may include a user profile 310 with a user ID of “user A” and a user A history 312, a user profile 314 with a user ID of “user B” and a user B history 316, a user profile 318 with a user ID of “user C” and a user C history 320, and a user profile 322 with a user ID of “user D” and a user D history 324. In one example, each of user A history 312, user B history 314, user C history 316, and user D history 318 may include one or more types of service experience history recorded for a particular customer identified in association with a user ID, where the service experience history may include, but is not limited to, arrival and departure times, items ordered, preparation and consumption times for items ordered, number of people in a group dining together, and other information gathered about the customer experience.

In one example, group database 132 may include a group profile 330 with a group ID of “group X”, identified for user IDs “user A” and “user B”, with a group X history 332 and a group ID of “group Y”, identified for user IDs “user A”, “user B”, and “user C”, with a group Y history 336. In one example, each of group X history 332 and group Y history 336 may include one or more types of service experience history recorded for a group identified by the user IDs of the customers in the group, where the service experience history may include, but is not limited to, arrival and departure times, items ordered, preparation and consumption times for items ordered, number of courses ordered, number of people in the group, and other information gathered about the group experience.

In one example, wait time management controller 150, to calculate real-time wait time estimates 152, may first calculate one or more average service experiences for each user individually, based on the user profile histories, such as calculating average services experiences for “user A” based on user A history 312, for “user B” based on user B history 316, for “user C” based on user C history 320, and for “user D” based on user D history 324. In one example, for each group, wait time management controller 150 may aggregate the individual average service experiences, along with service experiences for the group in group X history 332 and group Y history 336, to compute average service experiences for the group. Based on the average service experiences for the group computed for the current visit, wait time management controller 150 computes a separate wait time estimate for each group, where the wait time estimate indicates the estimated amount of time remaining before the group departs from a current service area and the service area will be available for a next party. For example, wait time management controller 150 dynamically calculates a wait time estimate 333 in association with group X profile 330 and dynamically calculates a wait time estimate 337 in association with group Y profile 334.

In one example, while “user A” may have an individual history in user A history 312 and “user B” may have an individual history in user B history 316, when “user A” is eating with “user B”, the service experience patterns for “group X” may vary from the individual service experience. For example, group X history 332 may include an average stay time that is longer than the average stay time in user A history 312 or user B history 316 individually. For example, “user A” may have an average stay time of 30 minutes for lunches and “user B” may have an average stay time of an hour for lunches, however, when “user A” and “user B” eat together, in one example, “user A” and “user B” may generally meet for a business lunch that lasts an average time of an hour and a half. Group X history 332 may include an average stay time of an hour and a half to reflect the average stay time for the group including “user A” and “user B” only.

In another example, while “user A” may have an individual history in user A history 312, “user C” may have an individual history in user C history 320, and “user D” may have an individual history in user D history 324, when “user A” is eating with “user C” and “user D”, the service experience patterns for “group Y” may vary from the individual service experience. For example, group Y history 336 may include an average stay time that is shorter than the average stay time in group X history 332. For example, “user A” may have an average stay time of 30 minutes for lunches, “user C” may have an average stay time of 25 minutes for lunches, and “user D” may have an average stay time of 35 minutes for lunches, however, when “user A”, “user C”, and “user D” eat together, in one example, group Y history 336 may include an average stay time of 30 minutes.

In one example, user database 130 may also include a user profile specified for one or more visitors who are not uniquely identified, such as visitor profile 350. In one example, visitor profile 350 may include a visitor history 352 that includes average stay times by meal time and other averages calculated for customers at a service provider. In one example, visitor profile 350 may represent the initial profile set up for a new customer or may represent the profile used for a customer that is not uniquely identifiable. In one example, group database 132 may include a group profile 354 with a group ID “group Z” that includes “user A” and “visitor” identifiers. In one example, group Z history 356 may include computed averages, based on user A history 312 and visitor history 352. In addition, the computed averages may be further adjusted according to one or more rules, such as a worst-case condition rule, such that until visitor history 352 is updated to include the real-time actual service experience history of a unique customer, the averages computed based on group Z history 356 reflect worst-case conditions. In one example, wait time management controller 150 may calculate a wait time estimate 357 for group Z profile 354 that estimates a wait time until the group completes a meal and departs from a service area.

FIG. 4 illustrates one example of a block diagram of a wait time management controller for aggregating real-time wait time estimates based on service area size requirements for a particular user.

In one example, wait time management controller 150 may filter and aggregate data, such as the data managed by wait time management controller 150 in FIG. 3, for output to different interfaces. In one example, one or more output interfaces may include one or more interfaces visible to a service provider entity in one or more locations within a service provider venue. In another example, one or more output interfaces may include one or more interfaces of wait list service 156 or of GPS service 154. In one example, another output interface may include an interface visible to a particular potential customer.

In one example, wait time management controller 150 may associate each service area identifier 410, identifying a particular service area, with a current group ID 412, indicating the group ID from group database 132 associated with the particular service area. In addition, wait time management controller 150 may filter the wait time estimate calculated for current group ID 412, from group database 132, into a real-time wait estimate by service area 414 for service area identifier 410.

In one example, wait time management controller 150 may filter each record identified by service area identifier 410 into a record for a service provider identifier 420 for a particular service provider. In one example, service provider identifier 420 may include a number of service areas by party size 422, where service areas by party size 422 may include service area identifier 410 for each service area and a size of the service area. In one example, wait time management controller 154 may further filter a selection of service areas included in service areas by party size 422 for output based on selection criteria set for a service provider about which service areas to include for a particular time period. In one example, the selection criteria set for a service provider about which service areas to include in service areas by party system 422 for a particular time period may remove service areas that are reserved for specific parties or are not part of the service areas to be included in the wait time estimates published for the service provider.

In one example, wait time management controller 154 may aggregate each real-time wait estimate by service area 414 for each of the service areas identified in service areas by party size 422 into an estimated wait time for each service area by party size 424. In one example, by aggregating each real-time wait estimate 414 for each of the service areas in service areas by party size 422 into an estimated wait time for each service area, estimated wait time for each service area by party size 424 may be output to wait list service 156, for dynamically updating the real-time wait time estimate for each party already on a wait list based on the service area size reserved, and may be output to GPS service 154 for providing a real-time wait time estimate for parties requesting information about wait times for a service provider location, which may be further specified by service area size.

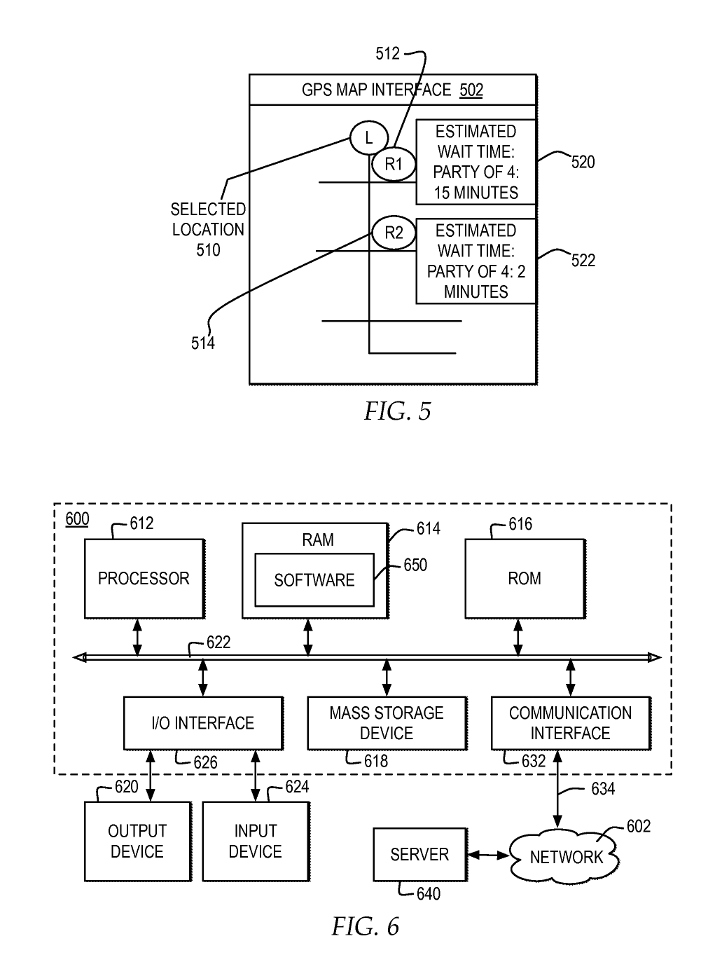

FIG. 5 illustrates one example of a block diagram of an output interface for a GPS service specifying real-time wait time estimates for service providers within a particular proximity of a location selected by a user.

In one example, a GPS map interface 502 is one example of an output interface of GPS restaurant service 158. In one example, GPS service 158 receives an input of a selected location 510, which identifies a location selected by the user. In one example, selected location 510 is a user's current location, as detected by a GSP monitoring tool of GPS service 158. In another example, selected location 510 is another location specified by a user.

In one example, GPS service 158 receives records for each service provider within a particular area, where each record may identify one or more of service provider identifier 420, service areas by party size 422, and the real-time estimated wait time for each service area by party size 424. In one example, each service provider may broadcast, within a local broadcast area, one or more of service provider identifier 420, service areas by party size 422, and estimated wait time for each service area by party size 424, where a portable wireless device may locally receive the broadcast data, and GPS service 158, running as an application on a GPS enabled wireless device, may integrate the broadcast information into GPS map interface 502. In another example, each service provider may transmit one or more of service provider identifier 420, service areas by party size 422, and estimated wait time for each service area by party size 424, to one or more server systems, where GPS service 158, running as an application on a GPS enabled wireless device, may access the information from the server system and integrate the accessed information into GPS map interface 502.

In one example, GPS service 158 receives, from a service provider identified as “R1”, illustrated within GPS map interface 502 at a position illustrated by reference numeral 512, an estimated wait time for each service area by party size 424, specified for R1, and filters the estimated wait time for each service area for a party of 4. GPS service 158 may output the filtered estimated wait time for each service area for a party of 4 in a textual interface 520 of GPS map interface 502, where for example, a real-time estimated wait time for a party of 4 at service provider “R1” is “15 minutes”. In another example, GPS service 158 may receive, from a service provider identified as “R2”, illustrated within GPS map interface 502 at a position illustrated by reference 514, an estimated wait time for each service area by party size 424, specified for R2, and filters the estimated wait time for each service area for a party of 4. GPS service 158 may output the filtered estimated wait time for each service area for a part of 4 in a textual interface 522 of GPS map interface 502, where for example, a real-time estimated wait time for a party of 4 at service provider “R2” is “2 minutes”. In another example, estimated wait times may be output as audio indicators, tactile indicators, or through other output interfaces.

In the example, while service provider “R1”, at the position illustrated at reference numeral 512, is positioned closer to selected location 510 than service provider “R2”, at the position illustrated at reference numeral 514, the real-time estimated wait time for a party of 4 at service provider “R2” is less than the real-time estimated wait time for a party of 4 at service provider “R1”. In addition, GPS service 158 may receive updates to the real-time estimated wait times for a party of 4 for each of the service providers and dynamically update textual interface 520 and textual interface 522 as updates are received. In addition, GPS service 158 may receive information about traffic and estimated travel times between a selected location 510 and service provider locations such as “R1” and “R2” and update GPS map interface 502 with the traffic and estimated travel times, including the feasibility of a user arriving at a service provider location in time to be seated at a service area if the user selects join a wait list or make a reservation. In one example, while the estimated wait time for a party of 4 at service provider “R1” is longer than the estimated wait time for a party of 4 at service provider “R2”, the traffic between selected location 510 and service provider “R2” may include delays, which could be a delay longer than the wait at service provider “R1”, which may provide the user with incentive to select to join the wait list at service provider “R1”.

In one example, a user may select textual interface 520 to select to join the wait list of a service area at service provider “R1” and may select textual interface 522 to select to join the wait list of a service area at service provider “R2”. In one example, GPS service 158 may interface with wait list service 159 for a selected service provider to add a user to a wait list for a selected service provider. Once wait list service 159 confirms the user is added to the wait list, GPS map interface 502 may continue to receive updates to the real-time estimated wait times for the party of 4 for the wait list. In one example, wait list service 159 may also manage reservations, where a user may select, via GPS map interface 502 to request a reservation for a service provider, as an alternative to joining the wait list for the service provider.

In additional or alternate embodiments, GPS map interface 502 may include additional or alternate information, such as, but not limited to, service provider reviews. In addition, GPS map interface 502 may reflect one or more filters applied by GPS service 158, such as, but not limited to, a filter specifying a type of service provider, service provider rating requirement, and service provider cost.

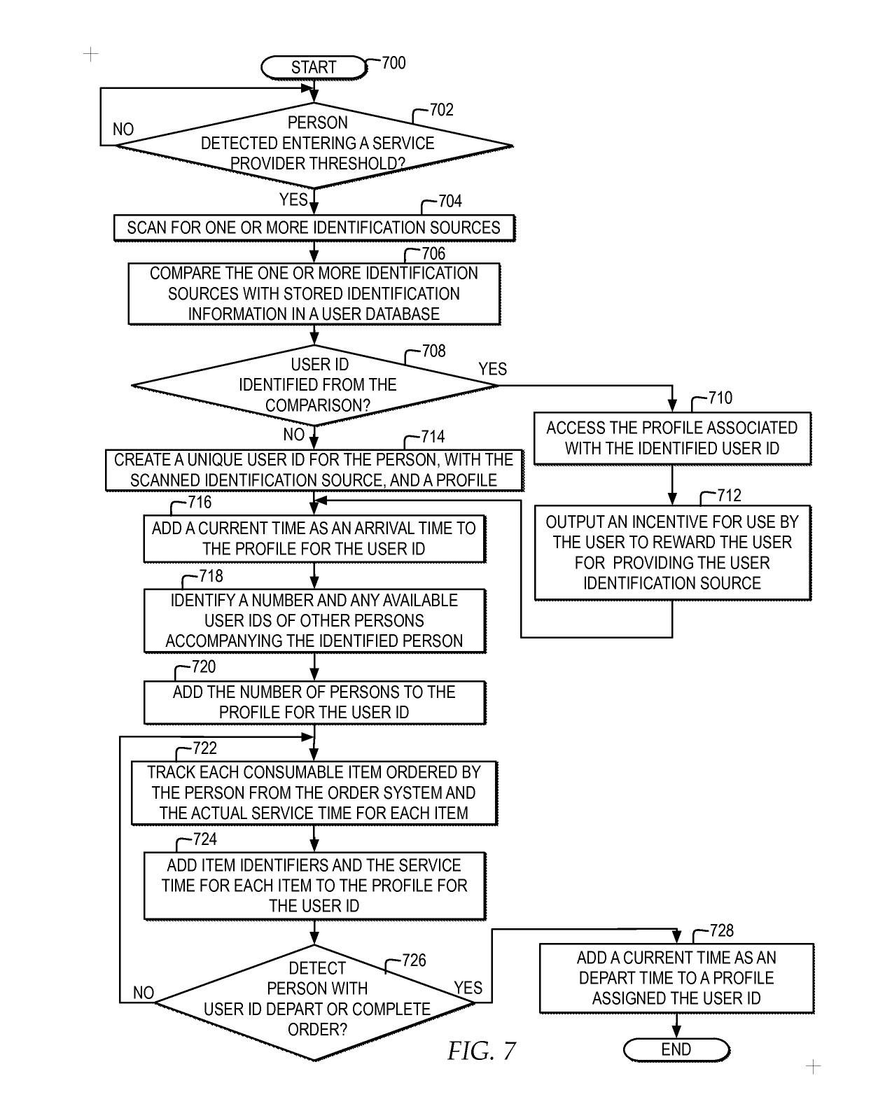

FIG. 6 illustrates a block diagram of one example of a computer system in which one embodiment of the invention may be implemented. The present invention may be performed in a variety of systems and combinations of systems, made up of functional components, such as the functional components described with reference to a computer system 600 and may be communicatively connected to a network, such as network 602.

Computer system 600 includes a bus 622 or other communication device for communicating information within computer system 600, and at least one hardware processing device, such as processor 612, coupled to bus 622 for processing information. Bus 622 preferably includes low-latency and higher latency paths that are connected by bridges and adapters and controlled within computer system 600 by multiple bus controllers. When implemented as a server or node, computer system 600 may include multiple processors designed to improve network servicing power.

Processor 612 may be at least one general-purpose processor that, during normal operation, processes data under the control of software 650, which may include at least one of application software, an operating system, middleware, and other code and computer executable programs accessible from a dynamic storage device such as random access memory (RAM) 614, a static storage device such as Read Only Memory (ROM) 616, a data storage device, such as mass storage device 618, or other data storage medium. Software 650 may include, but is not limited to, code, applications, protocols, interfaces, and processes for controlling one or more systems within a network including, but not limited to, an adapter, a switch, a server, a cluster system, and a grid environment.

Computer system 600 may communicate with a remote computer, such as server 640, or a remote client. In one example, server 640 may be connected to computer system 600 through any type of network, such as network 602, through a communication interface, such as network interface 632, or over a network link that may be connected, for example, to network 602.

In the example, multiple systems within a network environment may be communicatively connected via network 602, which is the medium used to provide communications links between various devices and computer systems communicatively connected. Network 602 may include permanent connections such as wire or fiber optics cables and temporary connections made through telephone connections and wireless transmission connections, for example, and may include routers, switches, gateways and other hardware to enable a communication channel between the systems connected via network 602. Network 602 may represent one or more of packet-switching based networks, telephony based networks, broadcast television networks, local area and wire area networks, public networks, and restricted networks.

Network 602 and the systems communicatively connected to computer 600 via network 602 may implement one or more layers of one or more types of network protocol stacks which may include one or more of a physical layer, a link layer, a network layer, a transport layer, a presentation layer, and an application layer. For example, network 602 may implement one or more of the Transmission Control Protocol/Internet Protocol (TCP/IP) protocol stack or an Open Systems Interconnection (OSI) protocol stack. In addition, for example, network 602 may represent the worldwide collection of networks and gateways that use the TCP/IP suite of protocols to communicate with one another. Network 602 may implement a secure HTTP protocol layer or other security protocol for securing communications between systems.

In the example, network interface 632 includes an adapter 634 for connecting computer system 600 to network 602 through a link and for communicatively connecting computer system 600 to server 640 or other computing systems via network 602. Although not depicted, network interface 632 may include additional software, such as device drivers, additional hardware and other controllers that enable communication. When implemented as a server, computer system 600 may include multiple communication interfaces accessible via multiple peripheral component interconnect (PCI) bus bridges connected to an input/output controller, for example. In this manner, computer system 600 allows connections to multiple clients via multiple separate ports and each port may also support multiple connections to multiple clients.

In one embodiment, the operations performed by processor 612 may control the operations of flowchart of FIGS. 7-11 and other operations described herein. Operations performed by processor 612 may be requested by software 650 or other code or the steps of one embodiment of the invention might be performed by specific hardware components that contain hardwired logic for performing the steps, or by any combination of programmed computer components and custom hardware components. In one embodiment, one or more components of computer system 600, or other components, which may be integrated into one or more components of computer system 600, may contain hardwired logic for performing the operations of flowcharts in FIGS. 7-11.

In addition, computer system 600 may include multiple peripheral components that facilitate input and output. These peripheral components are connected to multiple controllers, adapters, and expansion slots, such as input/output (I/O) interface 626, coupled to one of the multiple levels of bus 622. For example, input device 624 may include, for example, a microphone, a video capture device, an image scanning system, a keyboard, a mouse, or other input peripheral device, communicatively enabled on bus 622 via I/O interface 626 controlling inputs. In addition, for example, output device 620 communicatively enabled on bus 622 via I/O interface 626 for controlling outputs may include, for example, one or more graphical display devices, audio speakers, and tactile detectable output interfaces, but may also include other output interfaces. In alternate embodiments of the present invention, additional or alternate input and output peripheral components may be added.

With respect to FIG. 6, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the hardware depicted in FIG. 6 may vary. Furthermore, those of ordinary skill in the art will appreciate that the depicted example is not meant to imply architectural limitations with respect to the present invention.

FIG. 7 illustrates a high level logic flowchart of a process and computer program for managing individual customer detection and profile management for a service provider.

In one example, the process and computer program starts at block 700 and thereafter proceeds to block 702. Block 702 illustrates a determination whether a person is detected entering a service provider threshold. At block 702, if a person is detected entering a service provider threshold, then the process passes to block 704. Block 704 illustrates scanning for one or more identification sources. Next, block 706 illustrates comparing the one or more scanned identification sources with stored identification information in a user database. Thereafter block 708 illustrates a determination whether a user ID is identified from a comparison of the one or more scanned identification sources with stored identification information in the database.

At block 708, if there is not a user ID identified from the comparison, then the process passes to block 714. Block 714 illustrates creating a unique user ID for the person, with the scanned identification source, and a profile. Next, block 716 illustrates adding a current time as an arrival time to the profile for the user ID. Next, block 718 illustrates identifying a number and any available user IDs of the other persons accompanying the identified person. Thereafter, block 720 illustrates adding the number of persons to the profile for the user ID. Next, block 722 illustrates tracking each consumable item order by the person from the order system and the actual service time for each time. In one example, the service time for each item may include one or more of the time required to enter an order for the item, the time required to prepare the item, and the time required to serve the item. Thereafter, block 724 illustrates adding item identifiers and the service time for each item to the profile for the user ID. Next, block 726 illustrates a determination whether the person identified with the user ID is detected departing or completing an order. At block 726, if the person with the user ID is not detected departing or completing an order, then the process returns to block 722. At block 726, if the person with the user ID is detected departing or completing an order, then the process passes to block 728. Block 728 illustrates adding a current time as a depart time to a profile assigned to the user ID, and the process ends.

At block 708, if there is a user ID identified from the comparison, then the process passes to block 710. Block 710 illustrates accessing the profile associated with the identified user. Next, block 712 illustrates outputting an incentive for use by the user to reward the user for providing the user identification source, and the process passes to block 716.

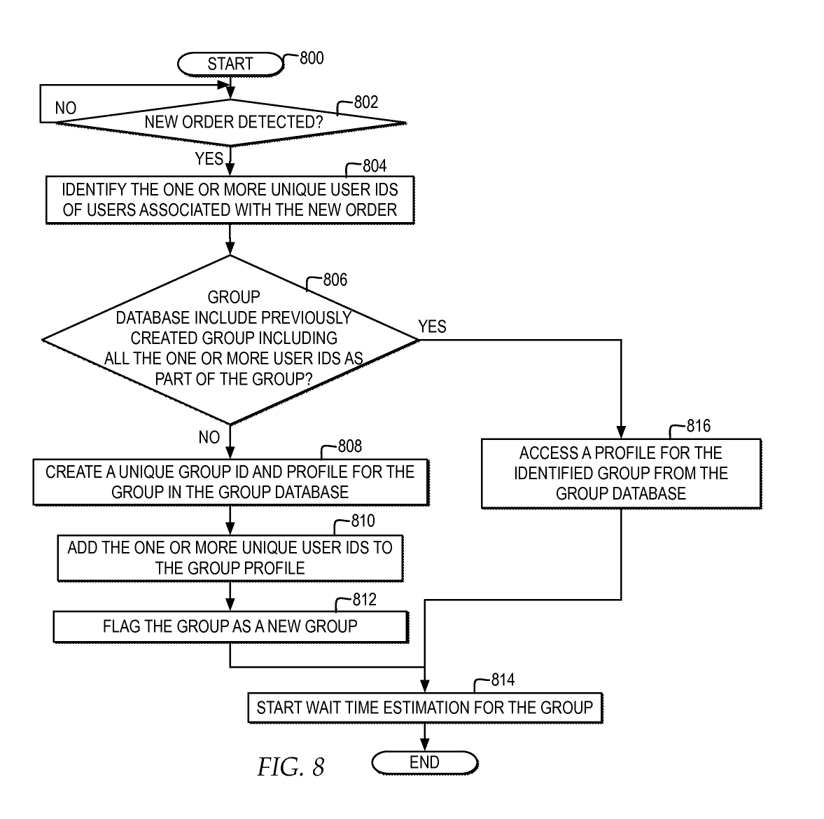

FIG. 8 illustrates a high level logic flowchart of a process and computer program for managing group customer detection and profile management for a service provider.

In one example, the process and computer program starts at block 800 and thereafter proceeds to block 802. Block 802 illustrates a determination whether a new order is detected. At block 802, if a new order is detected, then the process passes to block 804. Block 804 illustrates identifying the one or more unique user IDs of users associated with the new order. Next, block 806 illustrates a determination whether a group database includes a previously created group including all of the one or more user IDs as part of the group. At block 806, if the group database does not include a previously created group including all of the one or more user IDs as part of the group, then the process passes to block 808. Block 808 illustrates creating a unique group ID and profile for the group in the group database. Next, block 810 illustrates adding the one or more unique user IDs to the group profile. Thereafter, block 812 illustrates flagging the group as a new group. Next, block 814 illustrates starting a wait time estimation for the group, and the process ends.

Returning to block 806, if the group database includes a previously created group including all of the one or more user IDs as part of the group, then the process passes to block 816. Block 816 illustrates accessing the profile for the identified group from the group database, and the process passes to block 814.

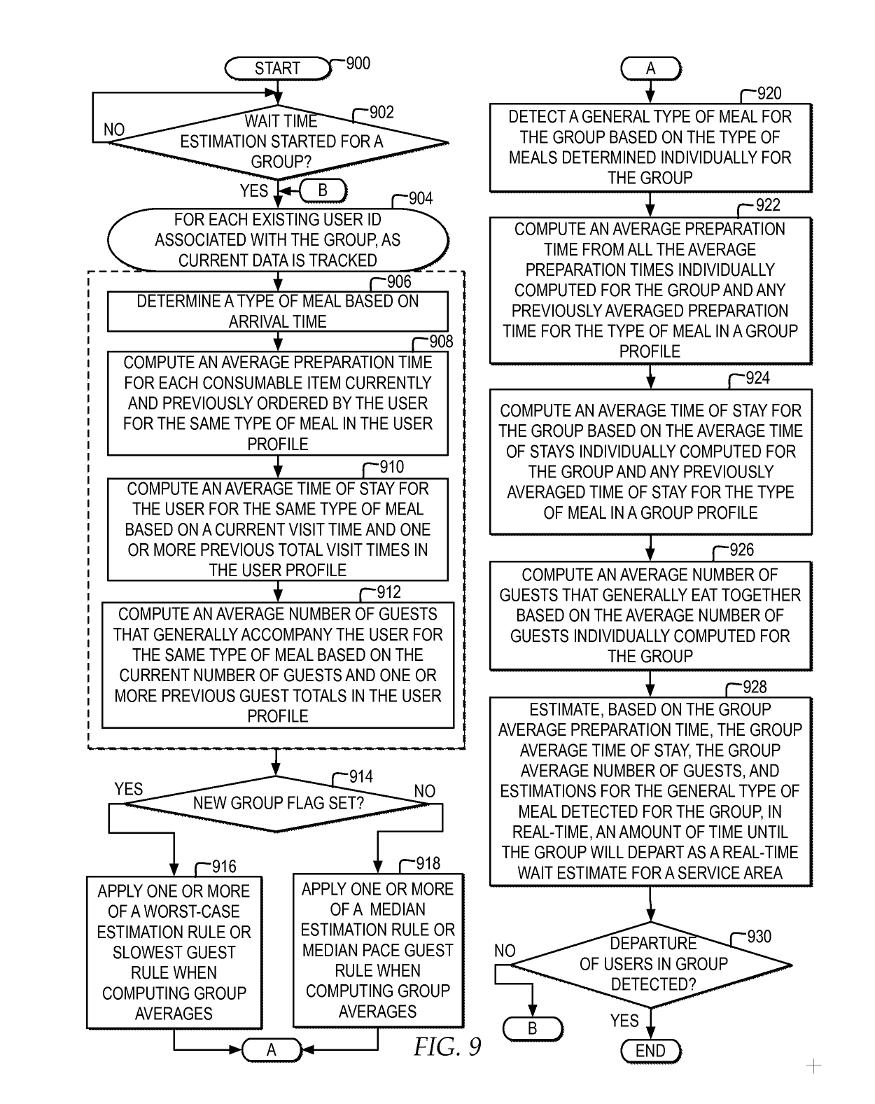

FIG. 9 illustrates a high level logic flowchart of a process and computer program for estimating a wait time for a service area.

In one example, the process and computer program starts at block 900 and thereafter proceeds to block 902. Block 902 illustrates a determination whether a wait time estimation is started for a group. At block 902, if a wait time estimated is started for a group, then the process passes to block 904. Block 904 illustrates, for each existing user ID associated with a group, as current data is tracked, block 906, block 908, block 910, and block 912. Block 906 illustrates determining a type of meal based on the individual user arrival time. Next, block 908 illustrates computing an average preparation time for each consumable item currently and previously ordered by the user for the same type of meal in the user profile for the user ID. Next, block 910 illustrates computing an average time of stay for the user for the same type of meal based on a current visit time and one or more previous total visit times in the user profile for the user ID. Next, block 912 illustrates computing an average number of guests that generally accompany the user for the same type of meal based on the current number of guests and one or more previous guest totals in the user profile. In one example, the determination in block 906, and the computations in block 908, block 910, and block 912 may be dynamically performed as the current data tracked for an individual is updated.

Next, block 914 illustrates a determination whether the group that the wait time estimation is started for is flagged as a new group. At block 914, if the group that the wait time estimation is started for is flagged as a new group. At block 914, if a group is flagged as a new group, then the process passes to block 916. Block 916 illustrates applying one or more of a worst-case estimation rule or slowest guest room when computing group averages, and the process passes to block 920. Returning to block 914, if a group is not flagged as a new group, then the process passes to block 918. Block 918 illustrates applying one or more of a media estimation rule or median pace guest rule when computing group averages, and the process passes to block 920.

Block 920 illustrates detecting a general type of meal for the group based on the type of meals determined individually for the users in the group. Next, block 922 illustrates computing an average preparation time from all the average preparation times individually computed for the group and any previously averaged preparation time for the type of meal in a group profile for the group. Next, block 924 illustrates computing an average time of stay for the group based on the average time of stays individually computed for the group and any previously averaged time of stay for the type of meal in a group profile for the group. Thereafter, block 926 illustrates computing an average number of guests that generally eat together based on the average number of guests individually computed for the group. Next, block 928 illustrates estimating, based on the group average preparation time, the group average time of stay, the group number of guests, and estimations for the general type of meal detected for the group, in real-time, an amount of time until the group will depart as a real-time wait estimate for a service area. Thereafter, block 930 illustrates a determination whether the departure of the users in the group is detected. At block 930, if the departure of the users in the group is not detected, then the process returns to block 904. At block 930, if the departure of the users in the group is detected, then the process ends.

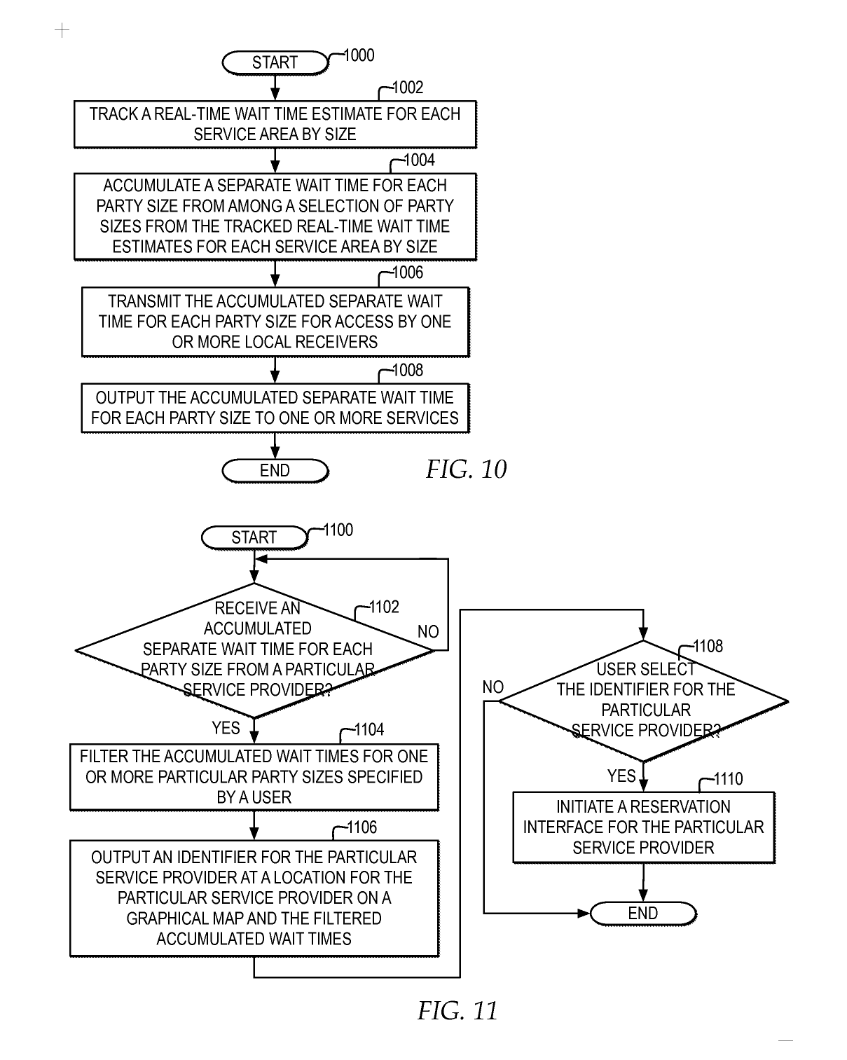

FIG. 10 illustrates a high level logic flowchart of a process and computer program for determining a wait time estimate by service area size.

In one example, the process and computer program starts at block 1000 and thereafter proceeds to block 1002. Block 1002 illustrates tracking a real-time wait time estimate for each service area by size. Next, block 1004 illustrates accumulating a separate wait time for each party size from among a selection of party sizes from the tracked real-time wait time estimates for each service area by size. Thereafter, block 1006 illustrates transmitting the accumulated separate wait time for each party size for access by one or more local receivers. Next, block 1008 illustrates outputting the accumulated separate wait time for each party size to one or more services, and the process ends.

FIG. 11 illustrates a high level logic flowchart of a process and computer program for managing output of accumulated wait times by party size through a location based service.

In one example, the process and computer program starts at block 1100 and thereafter proceeds to block 1102. Block 1102 illustrates a determination whether a service receives an accumulated separate wait time for each party size from a particular service provider. In one example, the service may pull the information. In another example, the information may be pushed to the service. At block 1102, if a service receives accumulated separate wait times for each party size from a particular service provider, then the process passes to block 1104. Block 1104 illustrates filtering the accumulated wait times for one or more particular party sizes specified by a user. Next, block 1106 illustrates outputting an identifier for the particular service provider at a location for the particular service provider on a graphical map and the filtered accumulated wait times. Thereafter, block 1106 illustrates a determination whether the user selects an identifier for the particular service provider. At block 1108, if the user does not select an identifier for the particular service provider, then the process ends. At block 1108, if the user selects an identifier for the particular service provider, then the process passes to block 1110. Block 1110 illustrates initiating a reservation interface for the particular service provider, and the process ends.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method comprising:
a computer system dynamically computing, for each of one or more customers at a particular service area from among a plurality of service areas provided by a service provider over a period of time, an individual average service experience by each of the one or more customers from the service provider based on a current service experience and at least one previous individual service experience of each of the one or more customers;
the computer system dynamically computing, for a group of customers using the particular service area from among the one or more customers over the period of time, a group average service experience for the group of customers based on the individual average service experience by each of the one or more customers in the group of customers and at least one previous group service experience by the group of customers; and
the computer system dynamically estimating, based on the group average service experience, one or more wait times until the group completes use of the particular service area.

2. The method according to claim 1, further comprising:
the computer system dynamically generating one or more wait time estimates in real time for a particular user requesting a particular service area size met by a current service area size of the particular service area based on the one or more wait times and a current number of other users waiting in a queue for the particular service area size.

3. The method according to claim 2, further comprising:
the computer system dynamically generating the one or more wait time estimates in real time for the particular user requesting the particular service area size met by the current service area size of the service area based on the one or more wait times for the particular service area, other wait times estimated for other service areas of a plurality of service areas of the particular service area size in a service provider, and the current number of other users waiting in the queue for the particular service area size.

4. The method according to claim 2, further comprising:
the computer system outputting the one or more wait time estimates for the particular user in an output interface illustrating a map comprising a location of the service provider comprising the service area, the wait time estimate output in association with the location of the service provider within the map, the wait time estimate output dynamically updated in real-time for each of the one or more wait time estimates.

5. The method according to claim 1, wherein a computer system dynamically computing, for each of one or more customers at a particular service area from among a plurality of service areas in a service provider over a period of time, an individual average service experience by each of the one or more customers at the service provider based on a current service experience and at least one previous individual service experience of each of the one or more customers further comprises:
the computer system dynamically determining, for each of the one or more customers, a type of meal from among a plurality of types of meals based on a time of an arrival of each of the one or more customers;
the computer system dynamically computing, for each of the one or more customers, an average preparation and consumption time for each of one or more consumable items ordered based on a current preparation and consumption time during the period of time and one or more previous preparation and consumption times of the at least one previous individual service experience of each of the one or more customers; and
the computer system dynamically computing, for each of the one or more customers, an average time of stay at the service provider for the type of meal for each of the one or more customers based on a current amount of time since the time of the arrival during the period of time and one or more previous time of stay of the at leas tone previous individual service experience of each of the one or more customers.

6. The method according to claim 1, wherein the computer system dynamically computing, for a group of customers using the particular service area from among the one or more customers over the period of time, a group average service experience for the group of customers based on the individual average service experience by each of the one or more customers in the group of customers and at least one previous group service experience by the group of customers further comprises:
the computer system dynamically computing, for the group of customers, an average preparation and consumption time for each of one or more consumable items ordered for the group based the individual average service experience by each of the one or more customers in the group during the period of time and one or more previous preparation and consumption times of the at least one previous group service experience by the group of customers; and
the computer system dynamically computing, for the group of customers, an average time of stay at the service provider for a time of arrival of the group of customers based on a current amount of time since the time of the arrival during the period of time, the individual average service experience by each of the one or more customers in the group, and one or more previous time of stay of the at least one previous group service experience of the group.

7. The method according to claim 1, further comprising:
the computer for detecting the one or more customers from scanning each of the one or more customers for one or more identification sources within the service provider; and
the computer for identifying, from the one or more identification sources, the one or more customers in a user database comprising a plurality of user profiles, for accessing one or more history records for the one or more customers, each of the one or more history records specifying at least one previous individual service experience of each of the one or more customers.

8. The method according to claim 1, further comprising:
the computer system determining a separate unique identifier for each of the one or more customers;
the computer system searching one or more group profiles for each separate unique identifier for each of the one or more customers at the particular service area, each group profile specifying a selection of unique identifiers; and
the computer system, responsive to detecting a particular group profile from among the one or more group profiles comprising each separate unique identifier for each of the one or more customers at the particular service area, accessing the group profile for the particular service area, the group profile comprising a group history specifying the at least one previous group service experience by the group of customers.

9. The method according to claim 8, further comprising:
the computer system, responsive to not detecting any group profile from among the one or more group profiles comprising each separate unique identifier for each of the one or more customers at the particular service area, creating a group profile for the particular service area with each separate unique identifier and applying a worst case estimation rule when computing the group average service experience for the group of customers.

10. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions to dynamically compute, for each of one or more customers at a particular service area from among a plurality of service areas provided by a service provider over a period of time, an individual average service experience by each of the one or more customers from the service provider based on a current service experience and at least one previous individual service experience of each of the one or more customers;
program instructions to dynamically compute, for a group of customers using the particular service area from among the one or more customers over the period of time, a group average service experience for the group of customers based on the individual average service experience by each of the one or more customers in the group of customers and at least one previous group service experience by the group of customers; and
program instructions to dynamically estimate, based on the group average service experience, one or more wait times until the group completes use of the particular service area.

11. The computer system according to claim 10, the stored program instructions further comprising:
program instructions to dynamically generate one or more wait time estimates in real time for a particular user requesting a particular service area size met by a current service area size of the particular service area based on the one or more wait times and a current number of other users waiting in a queue for the particular service area size.

12. The computer system according to claim 11, the stored program instructions further comprising:
program instructions to dynamically generate the one or more wait time estimates in real time for the particular user requesting the particular service area size met by the current service area size of the service area based on the one or more wait times for the particular service area, other wait times estimated for other service areas of a plurality of service areas of the particular service area size in a service provider, and the current number of other users waiting in the queue for the particular service area size.

13. The computer system according to claim 11, the stored program instructions further comprising:
program instructions to output the one or more wait time estimates for the particular user in an output interface illustrating a map comprising a location of the service provider comprising the service area, the wait time estimate output in association with the location of the service provider within the map, the wait time estimate output dynamically updated in real-time for each of the one or more wait time estimates.

14. The computer system according to claim 10, the stored program instructions further comprising:
program instructions to dynamically determine, for each of the one or more customers, a type of meal from among a plurality of types of meals based on a time of an arrival of each of the one or more customers;
program instructions to dynamically compute, for each of the one or more customers, an average preparation and consumption time for each of one or more consumable items ordered based on a current preparation and consumption time during the period of time and one or more previous preparation and consumption times of the at least one previous individual service experience of each of the one or more customers; and
program instructions to dynamically compute, for each of the one or more customers, an average time of stay at the service provider for the type of meal for each of the one or more customers based on a current amount of time since the time of the arrival during the period of time and one or more previous time of stay of the at leas tone previous individual service experience of each of the one or more customers.

15. The computer system according to claim 10, the stored program instructions further comprising:
program instructions to dynamically compute, for the group of customers, an average preparation and consumption time for each of one or more consumable items ordered for the group based the individual average service experience by each of the one or more customers in the group during the period of time and one or more previous preparation and consumption times of the at least one previous group service experience by the group of customers; and
program instructions to dynamically compute, for the group of customers, an average time of stay at the service provider for a time of arrival of the group of customers based on a current amount of time since the time of the arrival during the period of time, the individual average service experience by each of the one or more customers in the group, and one or more previous time of stay of the at least one previous group service experience of the group.

16. The computer system according to claim 10, the stored program instructions further comprising:
program instructions to detect the one or more customers from scanning each of the one or more customers for one or more identification sources within the service provider; and
program instructions to identify, from the one or more identification sources, the one or more customers in a user database comprising a plurality of user profiles, for accessing one or more history records for the one or more customers, each of the one or more history records specifying at least one previous individual service experience of each of the one or more customers.

17. The computer system according to claim 10, the stored program instructions further comprising:
program instructions to determine a separate unique identifier for each of the one or more customers;
program instructions to search one or more group profiles for each separate unique identifier for each of the one or more customers at the particular service area, each group profile specifying a selection of unique identifiers; and
program instructions, responsive to detecting a particular group profile from among the one or more group profiles comprising each separate unique identifier for each of the one or more customers at the particular service area, to access the group profile for the particular service area, the group profile comprising a group history specifying the at least one previous group service experience by the group of customers.

18. The computer system according to claim 17, the stored program instructions further comprising:
program instructions, responsive to not detecting any group profile from among the one or more group profiles comprising each separate unique identifier for each of the one or more customers at the particular service area, to create a group profile for the particular service area with each separate unique identifier and applying a worst case estimation rule when computing the group average service experience for the group of customers.

19. A computer program product comprising one or more computer-readable storage devices and program instructions, stored on at least one of the one or more storage devices, the stored program instructions comprising:
program instructions to dynamically compute, for each of one or more customers at a particular service area from among a plurality of service areas provided by a service provider over a period of time, an individual average service experience by each of the one or more customers from the service provider based on a current service experience and at least one previous individual service experience of each of the one or more customers;
program instructions to dynamically compute, for a group of customers using the particular service area from among the one or more customers over the period of time, a group average service experience for the group of customers based on the individual average service experience by each of the one or more customers in the group of customers and at least one previous group service experience by the group of customers; and
program instructions to dynamically estimate, based on the group average service experience, one or more wait times until the group completes use of the particular service area.

20. The computer program product according to claim 19, the stored program instructions further comprising:
program instructions to dynamically generate one or more wait time estimates in real time for a particular user requesting a particular service area size met by a current service area size of the particular service area based on the one or more wait times and a current number of other users waiting in a queue for the particular service area size.
